(19) United States
(12) Patent Application Publication
(10) Pub. No.: US 2011/0263209 A1
(43) Pub. Date: Oct. 27, 2011

(54) QUIET PERIOD FORMATION AND MAINTENANCE IN RADIO SYSTEMS

(75) Inventors: Mika KASSLIN, Espoo (FI); Juha Salokannel, Tampere (FI); Jari Junell, Espoo (FI)

(73) Assignee: Nokia Corporation, Espoo (FI)

(21) Appl. No.: 12/765,544

(22) Filed: Apr. 22, 2010

(51) Int. Cl. H04B 17/00

(52) U.S. Cl. 455/67.11

(57) ABSTRACT

A system for quiet period determination. An apparatus may listen for potential silent periods to occur in an environment, and if detected, the potential silent periods may be compared to quiet period criteria to determine if they are actual silent periods. If at least two subsequent actual silent periods are determined, the apparatus may adopt quiet period timing and duration based on the actual silent periods. Alternatively, the apparatus may establish new quiet period timing and duration based on the quiet period criteria.

### BACKGROUND

1. Field of Invention

The present invention relates to wireless communication, and in particular, to managing the operation of wireless networks that are operating in an environment shared by previously existing wireless equipment so as not to interfere with legacy apparatus operation.

2. Background

Advancements in communication-related technology have helped to proliferate the integration of communication-related functionality in everyday applications. In particular, some ability to interact electronically using wired and/or wireless communication is now expected for many existing and emerging applications. Where wireless communication is being employed, wireless transports may be utilized to send electronic data to multiple destinations. These destinations may reside in different locations, and thus, more than one wireless transport may be employed in a single apparatus in order to address these communication needs. Further, the suppliers and consumers of electronic information may not operate using the same forms of communication, so these apparatuses must be able to change communication configuration in order to support less-flexible applications (e.g., processing, size or power limited apparatuses).

However, while enhanced functionality may be realized through the proliferation of wireless communication, the increasing inclusion of wireless support in different applications will unavoidably result in increased wireless signal traffic. As wireless protocols may operate in the same or similar bandwidths, interference may occur when the protocols operate concurrently. This would especially be the case when transmitters and/or receivers are in close proximity, such as in an apparatus that supports multiple protocols. Moreover, other sources of interference may exist within an operational environment. For example, electromagnetic fields may be generated by electronic apparatuses or power systems. Further, legacy wireless communication signals, such as AM/FM radio and television (TV) broadcast signals, may operate in frequency bands that fall very close to emerging wireless protocols, which may also cause signal interference.

Legacy broadcast signals may be especially problematic when attempting to reuse bandwidth that was traditionally reserved for AM/FM radio and/or TV broadcasts. For example, in the U.S. the Federal Communication Commission (FCC) has decided that TV white space, or the operational frequencies that were previously reserved for TV channels that is not currently in use, is available for unlicensed broadband use. However, operating in these sections of unused TV broadcast spectrum may entail certain requirements and/or impediments. More specifically, in addition to rules prohibiting interference with certain legacy apparatuses that operate within this spectrum, the unlicensed nature of these unused channels means that many apparatuses may be operating in this bandwidth, resulting in potential interference coming from many sources.

### SUMMARY

Various example embodiments of the present invention may be directed to a method, computer program product, apparatus and system for quiet period determination. An apparatus may listen for potential silent periods to occur in an environment, and if detected, the potential silent periods may be compared to quiet period criteria to determine if they are actual silent periods. If at least two subsequent actual silent periods are determined, the apparatus may adopt quiet period timing and duration based on the actual silent periods. Alternatively, the apparatus may establish new quiet period timing and duration based on the quiet period criteria.

In at least one example implementation, the apparatus may be a master apparatus in a wireless network operating in the environment (e.g., a TV White Space environment). The master apparatus may listen for potential silent periods for a predetermined amount of time, and upon detection of a potential silent period may compare the duration of the potential silent period to a minimum and maximum quiet period duration. If the potential silent period falls within the quiet period duration criteria, the timing of at least two potential silent periods may be compared to a minimum and maximum quiet period interval. If the potential silent periods fall within this second quiet period criteria, then the potential silent periods may be deemed actual silent periods and quiet period timing and duration may be adopted based upon the actual silent periods. If no potential silent periods are detected in the environment or no actual silent period are determined, new quiet period timing and duration may be established based upon the quiet period criteria.

In accordance with at least one embodiment of the present invention, silent periods based on the quiet period timing and duration may then be established in the wireless network by the master apparatus. The silent periods may be established in at least pairs, and communication may be prohibited in the wireless network during the silent periods. While the established duration of silent periods may fall within the quiet period minimum and maximum, it may also be possible for excess idle time in the wireless network to cause the actual duration of silent periods to become greater than the maximum, resulting in oversized silent periods. The number of oversized silent periods that occur successively may be limited by an oversized silent period limit. Moreover, the occurrence of successive oversized silent periods may cause the master apparatus to maintain timing in the wireless network by establishing artificial signaling.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses example apparatuses, communication configuration and network architecture usable in implementing at least one embodiment of the present invention.

FIG. 2 discloses additional detail with respect to example communication interfaces that may be usable with various embodiments of the present invention.

FIG. 3 discloses an example of an operational environment in which at least one embodiment of the present invention may be implemented.

FIG. 4A discloses further detail regarding the example operational environment that was initially disclosed in FIG. 3.

FIG. 4B discloses examples of other potential signal sources that may exist in the example operational environment that was initially disclosed in FIG. 3.

FIG. 5 discloses an example Cognitive Radio (CR) implementation in accordance with at least one embodiment of the present invention.

FIG. 6 discloses example criteria that may be taken into consideration when operating a Cognitive Radio (CR) system in accordance with at least one embodiment of the present invention.

FIG. 7 discloses an example of apparatus interaction within a TVWS environment in accordance with at least one embodiment of the present invention.

FIG. 8 discloses an example environment including networks that do not support collaborative coexistence in accordance with at least one embodiment of the present invention.

FIG. 9 discloses example quiet period and silence period timing and duration in accordance with at least one embodiment of the present invention.

FIG. 10 discloses an example of quiet period listening and silent period duration and timing establishment in accordance with at least one embodiment of the present invention.

FIG. 11 discloses various examples of silent periods that may result from quiet period timing and duration in accordance with at least one embodiment of the present invention.

FIG. 12 discloses a flowchart for an example communication management process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

I. Example System with which Embodiments of the Present Invention May be Implemented

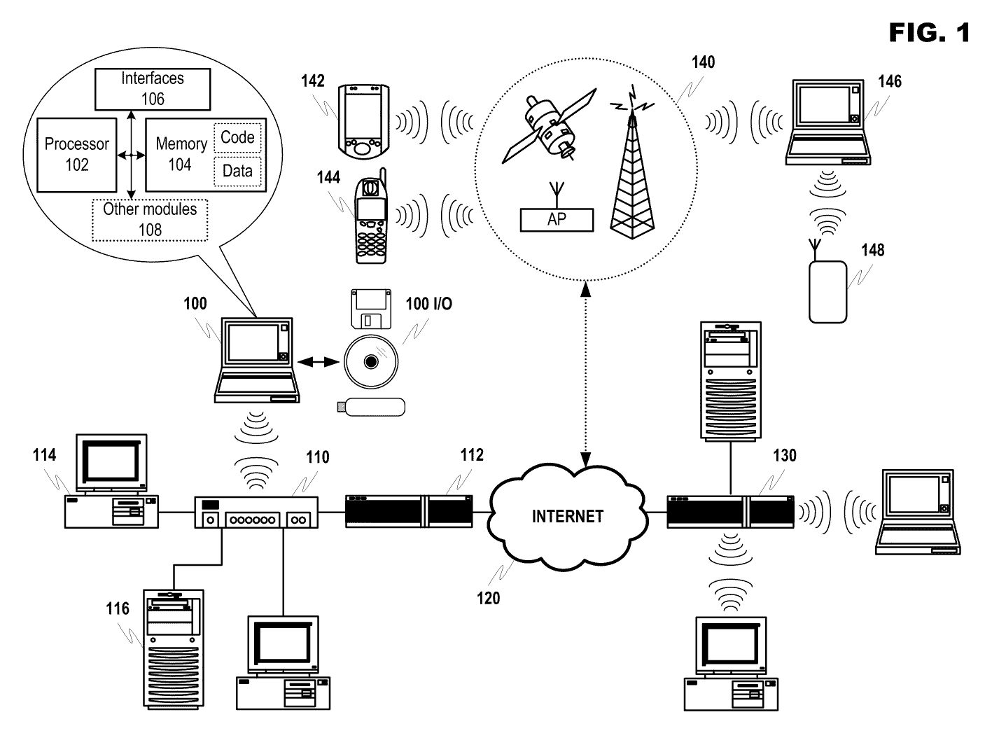

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication. Further, any or all of the disclosed apparatuses may engage in direct interaction, such as in the short-range wireless interaction shown between laptop 146 and wireless-enabled apparatus 148. Example wireless enabled apparatuses 148 may range from more complex standalone wireless-enabled devices to peripheral devices for supporting functionality in apparatuses like laptop 146.

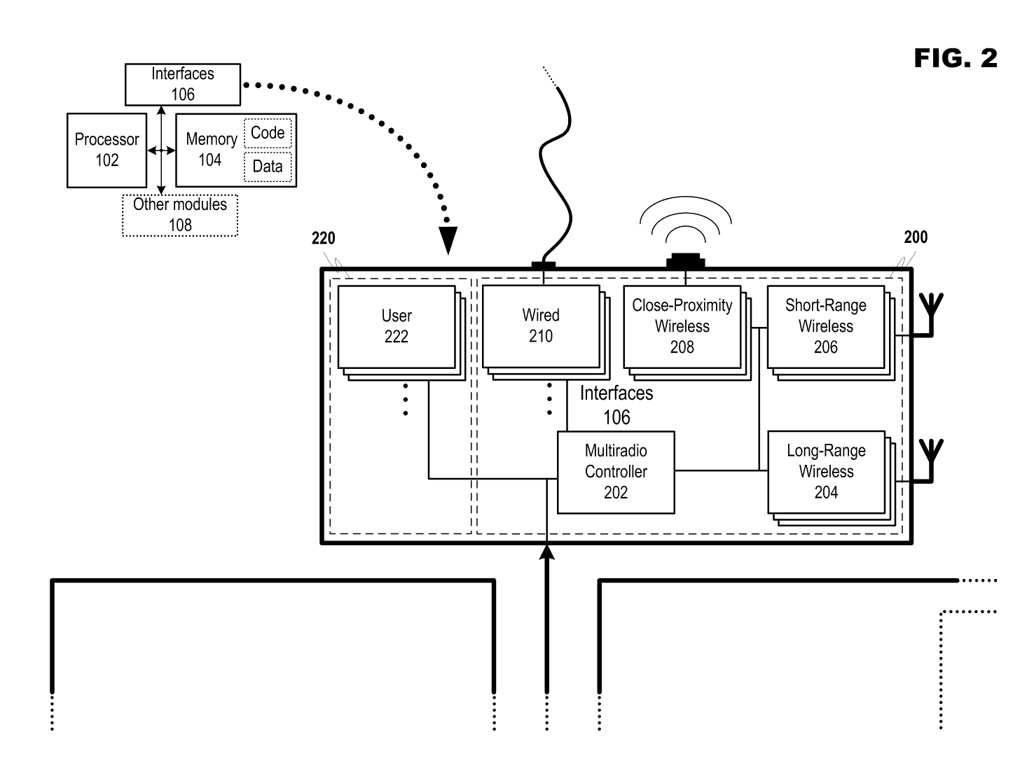

Further detail regarding example interface component 106, shown with respect to computing device 100 in FIG. 1, is now discussed with respect to FIG. 2. Initially, interfaces such as disclosed at 106 are not limited to use only with computing device 100, which is utilized herein only for the sake of explanation. As a result, interface features may be implemented in any of the apparatuses that are disclosed in FIG. 1 (e.g., 142, 144, etc.) As previously set forth, interfaces 106 may include interfaces both for communicating data to computing apparatus 100 (e.g., as identified at 200) and other types of interfaces 220 including, for example, user interface 222. A representative group of apparatus-level interfaces is disclosed at 200. For example, multiradio controller 202 may manage the interoperation of long range wireless interfaces 204 (e.g., cellular voice and data networks), short-range wireless interfaces 206 (e.g., Bluetooth and WLAN networks), close-proximity wireless interfaces 208 (e.g., for interactions where electronic, magnetic, electromagnetic and optical information scanners interpret machine-readable data), wired interfaces 210 (e.g., Ethernet), etc. The example interfaces shown in FIG. 2 have been presented only for the sake of explanation herein, and thus, are not intended to limit the various embodiments of the present invention to utilization of any particular interface. Embodiments of the present invention may also utilize interfaces that are not specifically identified in FIG. 2.

Multiradio controller 202 may manage the operation of some or all of interfaces 204-210. For example, multiradio controller 202 may prevent interfaces that could interfere with each other from operating at the same time by allocating specific time periods during which each interface is permitted to operate. Further, multiradio controller 202 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 202 may interact with interfaces 204-210 in FIG. 2.

### II. Example Operational Environment

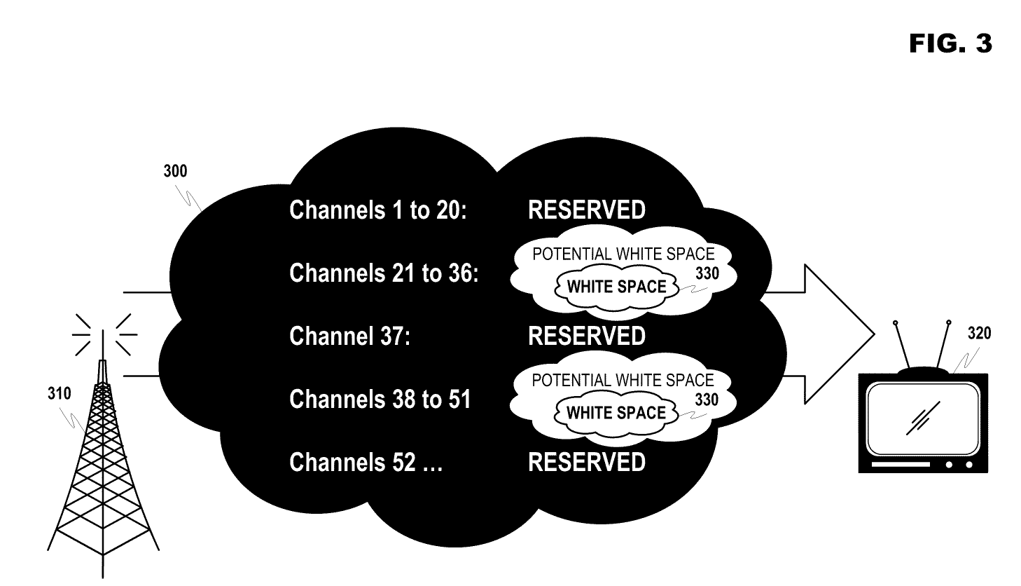

FIG. 3 discloses an example environment that will be utilized for explaining the various embodiments of the present invention. While a TV white space system will be utilized for the sake of example herein, the various example implementations of the present invention that will be disclosed below are not strictly limited only to this operational environment. As a result, various embodiments of the present invention may be applied to different situations that may have somewhat similar characteristics. For instance, such scenarios may include one or more apparatuses interacting wirelessly in an operational environment that is also experiencing substantial signal activity due to other signal sources that are also present in the environment.

FIG. 3 discloses an example of a rudimentary white space system. Initially, bandwidth 300 may be licensed to broadcasters 310. Bandwidth 300 may be separated into channels that are used by broadcasters 310 to send programming to TV 320. For example, each channel may be used by a broadcaster 310 to transmit audio/visual programming to TV 320, by wireless microphones, etc. However, some of bandwidth 300 that is licensed for TV programming may remain unused (e.g., there is no broadcaster using the channel, other signal sources may create interference within the frequency range that defines a channel, etc.). This unused space is identified in FIG. 3 as white space 330. White space 330 may therefore comprise some licensed bandwidth within bandwidth 300 that may be reallocated. TV white space (TVWS) in the U.S. may comprise TV channels 21-51, 470 MHz to 698 MHz, excluding channel 37. As a result, any channel that is not being used within the range of channels 21 to 36 and/or channels 38 to 51 may be reallocated for other uses, such as for unlicensed short-range wireless communication (e.g., allowing close-proximity wireless networks to be formed between apparatuses). There may also be unused VHF and UHF channels in which white space operation is permitted, but these channels are currently for fixed-to-fixed apparatus communication only.

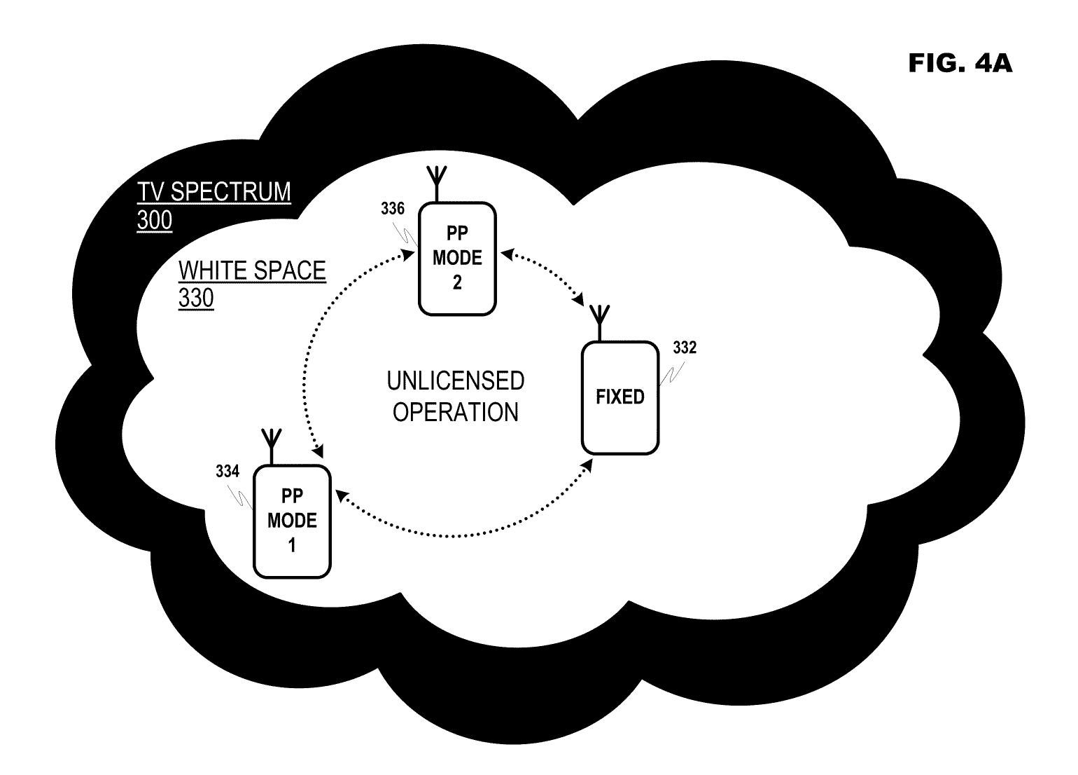

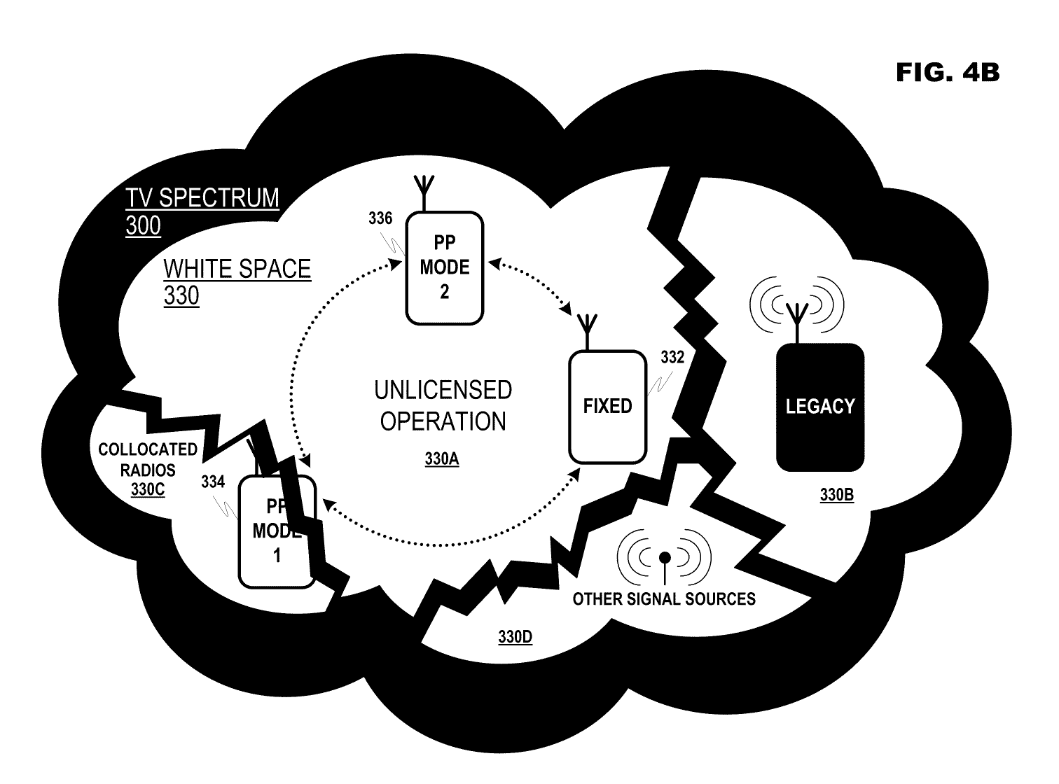

Now referring to FIG. 4A, the example of white space 330 as an environment in which apparatuses may interact is explored further. In TVWS network terminology there may be two categories of apparatus: fixed and personal/portable. Fixed apparatuses 334 are stationary, and thus, have a constant position over time. Personal/portable devices may be capable of moving, so their location may vary over time. Furthermore, personal/portable devices are categorized into PP Mode I apparatuses 334 and PP Mode II apparatuses 336. PP Mode II devices 336 can initiate networks (e.g., they can serve as access points in WLAN-type networks) as a master device. PP Mode I devices 334 can only operate as clients of TVWS networks, which may be controlled by either fixed apparatus 332 or PP Mode II device 336. Both fixed apparatuses 332 and personal/portable Mode II devices 336 may utilize spectrum sensing and database access to determine whether or not a channel is occupied by a primary user. In addition, a “special” type of apparatus (not pictured) may also be defined in TVWS networks. Such special apparatuses may be portable and may rely only on spectrum sensing to identify occupied channels.

Ideally, apparatuses 332, 334 and 336, as disclosed FIG. 4, may interact freely via wireless communication as long as they remain within the frequency range established for white space 330. However, in practice white space 330 may not be an ideal operational environment. This concept is discussed further with respect to FIG. 4B. In example scenarios where white space 330 is made available for unlicensed short-range wireless communication, many signal sources may exist within this frequency range, and as a result there may be many opportunities for interference to occur between these various sources. Initially, intra-apparatus interference (e.g., interference in an apparatus caused by other functionality occurring in the same apparatus) may exist. Co-located coexistence interference 330C means that devices may contain multiple radios that concurrently support wireless transports operating in proximate frequency bands, or that may otherwise still experience quality problems during simultaneous operation due to, for example, harmonic or inter-modulation interference. In this instance the multiple radios may cause interference between themselves. This is especially a problem if the apparatus is mobile cellular handset or other small factor device since the physical distance between the antennas is insubstantial (e.g., closer antennas=increased interference) and even the smallest leakage power can result in significant performance degradation. Transmission power level may also be a contributor to intra-apparatus interference, which may differ based on type of radio (e.g., cellular radio ˜2 W is stronger than short-range unlicensed radio ˜100 mW).

The Quality of Service (QoS) delivered by wireless transports may also depend on the sensitivity of the radio technology being employed (e.g., how resistant is the technology to interference). For example, severe co-located interference may occur when a high power radio transmits at the same time when low power radio is receiving. For example, if a device supports both Long Term Evolution (LTE) operating at 700 MHz and TVWS technology using wireless local area network (WLAN) technology where the TVWS channel exists at high end of TV band (e.g., ˜690 MHz), the interference between LTE and TVWS technology can be substantial. The aforementioned case is just an example. Other combinations may also prove problematic. For example, other signal sources 330D may comprise apparatuses whose signals are present within the operational environment but are not part of the short-range unlicensed wireless network formed as disclosed at 330A. Other signal sources 330D may comprise, for example, electronic or electromechanical apparatuses whose operation causes electromagnetic field (EMF) interference in the operational environment. Moreover, wireless-enabled apparatuses that are operating close by but are not participating in unlicensed operation 330A may also contribute to signal traffic.

Such wireless-enabled apparatuses may prove extremely problematic in TVWS network systems since there may be very strict sensing requirements of incumbent users (e.g., legacy users 330B). For example, in TVWS systems a device may be requested to sense if a channel is used by a primary user before initiating any communication in that radio channel. Primary users may include, for example, TV broadcasters, wireless microphones or other protected devices. More specifically, the FCC is currently requiring that devices must operate using a −114 dBm detection sensitivity, which may be subject to change depending on various criteria such as updated wireless management regulations, changes in environment (traffic), etc. Sensitivity requirements may also be different depending on region (e.g., vary by country, etc.). As a result, any other co-located or close-by radio should interfere less than the above value to avoid false positive detections of primary users. Traditionally it would be impossible to achieve this level of sensitivity without implementing application specific co-located coexistence detection. For this reason, TVWS networking may be considered the first practical application of cognitive radio.

### III. Example Cognitive Radio Implementation and Operation

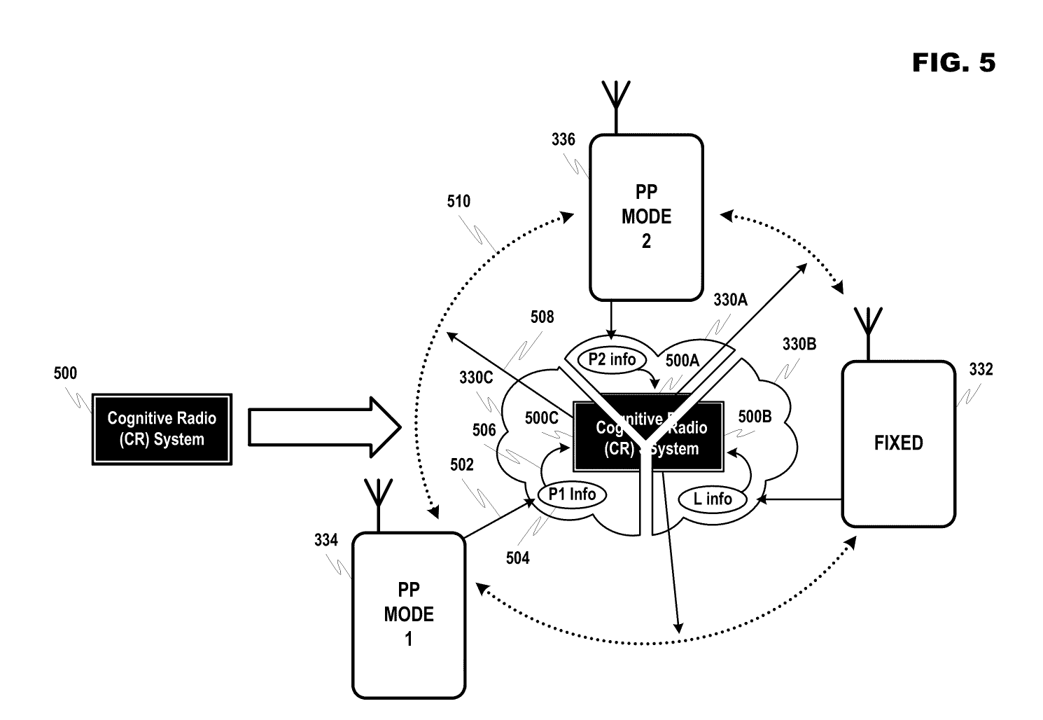

In accordance with at least one embodiment of the present invention, an example Cognitive Radio (CR) system 500 is disclosed in an example distributed arrangement in FIG. 5. Initially, a more general explanation of possible CR system operation will be disclosed herein, which is followed by a more specific description of how a CR system may be implemented in accordance with various embodiments of the present invention. More specifically, portions of CR 500 (e.g., 500A to C) may manage communication in operational environment sections 330A to 330C. However, the various example embodiments of the present invention are not specifically limited to the disclosed system, which has been provided for the sake of example herein. For example, CR system 500 may reside completely in a single apparatus or may be distributed amongst various apparatuses as shown at 500A to 500C. Some or all of the apparatuses 332-336 may provide information 504 to CR system 500, as shown at 506, which may use information 504 to formulate communication configuration information pertaining to some or all of apparatuses 332-336. Communication configuration information may comprise one or more preferred configurations for each apparatus (e.g., in the instance of synchronization information) or information usable by apparatuses 332-336 for formulating their own configuration. Configuration information 508 may then be made available to apparatuses 332-336 to facilitate the configuration of network communication.

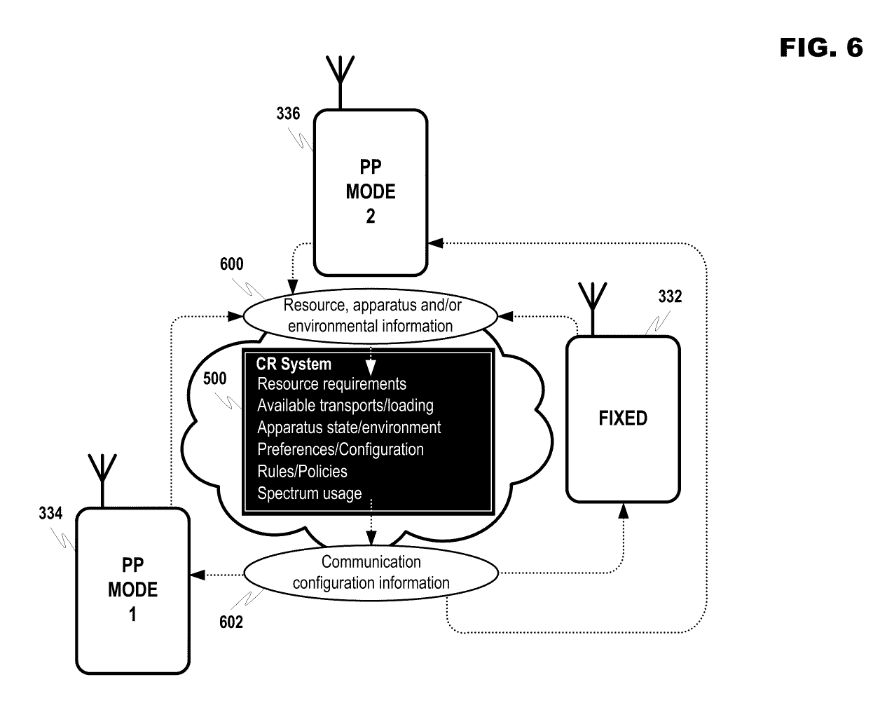

FIG. 6 discloses an example methodology by which CR system 500 may formulate communication configuration information in accordance with at least one embodiment of the present invention. Initially decision criteria may be provided at 600, the decision criteria comprising resource, apparatus and/or environmental information. Examples of resource information may include, but are not limited to, applications and/or services residing on an apparatus, hardware components that may be available in an apparatus (e.g., sensors, image capture devices like cameras, etc.), data stored on apparatuses, etc. Apparatus information may comprise, for example, communication transports supported by an apparatus, apparatus security requirements and information pertaining to the current operating condition of an apparatus (e.g., power level, active transports and corresponding traffic/pending messages for each, processor loading, etc.). Environmental information may encompass data obtained by an apparatus regarding the environment in which the apparatus is operating. For example, this type of information may include the current state of the transmission spectrum local to each apparatus or the indication of potential sources of interference in these areas. Potential sources of interference may be identified based on field sensors within the apparatus, packet loss experienced in communications over particular wireless transports, etc.

The decision criteria disclosed, for example, at 600 may be supplied to CR system 500 in response to a request message, may be provided periodically based, for example, on a predetermined time period, in response to changes occurring in the apparatuses, etc. CR system 500 may utilize the received decision criteria in one or more logical determination steps as shown in FIG. 6. For example, CR system 500 may consider the decision criteria in view of resource requirements such as communication link performance requirements (e.g., high speed and/or capacity for multimedia streaming), link security requirements for accessing private and/or sensitive information, etc. CR system 500 may further consider which communication transports are available, the loading of each of these transports system-wide, and the current state and/or environmental conditions corresponding to each apparatus. For example, apparatuses that have limited power and/or processing resources may be allowed to communicate using transports that help to conserve these resources. Further, apparatuses experiencing interference based on locally active transports or proximately-located sources of interference may be limited to using transports that are immune to these types of interference. Preferences/configuration may comprise non-condition or non-environmental provisions that control transport selection. For example, users may configure WLAN over high-speed cellular transports in order to save power, certain transports may be designated as always having priority (e.g., transport carrying voice data), etc. Rules/Policies may comprise, for example, regulatory rules that the nodes need to follow in their utilization of spectrum. Spectrum usage may further be utilized to determine the frequency spectrums that are preferred (or should be avoided) when establishing new communication links. In accordance with at least one embodiment of the present invention, some or all of these criteria may be employed when implementing communication in a TVWS environment. For example, the rules in CR 500 may protect operation for existing apparatuses by customizing the operation of TVWS apparatuses to avoid interference. Alternatively, rules in CR 500 may protect the operation of TVWS apparatuses by modifying other apparatus operation.

The culmination of the example logical decision steps shown in FIG. 5 may take the form of communication configuration information 502. This information may be provided in various formats, such as possible communication configurations that may be adopted by an apparatus. For example, possible communication configurations may comprise assigning one or more communication transports (e.g., low power) for use in accessing a certain apparatus. Requesting applications and/or required resources may also dictate the selection of transports having specific speed, capacity, error-correction, security characteristics, etc. Further, transports may be excluded from configurations used to access certain apparatuses based on the potential negative impact of interference sources that are local or proximately-located to the apparatus.

In accordance with at least one example embodiment of the present invention, it is also possible for communication configuration information to consist of data that is usable when apparatuses are configuring their own communications. For example, communication transports supported by an apparatus, encryption or error-checking functionality available in an apparatus, local interference information and/or local spectrum utilization information, apparatus condition information, etc. may be made available to other apparatuses that desire to access resources on the apparatus. These other apparatuses may then formulate their own configuration in view of the abilities and/or limitations of the apparatus to which communication is desired. In either situation provided above (e.g., the provision of one or more possible configurations or information usable by apparatuses when configuring a link), the configuration information may be accessed directly by requesting apparatuses (e.g., such as by the apparatuses querying configuration data stored in a particular format), may be provided in one or more messages transmitted from CR system 500 in response to apparatus requests, etc.

### IV. Implementation Example for Networks Supporting Collaborative Coexistence

In accordance with at least one embodiment of the present invention, CR system 500 may, alone or in combination with the functional aspects described above, be utilized to convey signal-related information usable for managing wireless communication in one or more apparatuses. Signal related information may pertain to the apparatus itself, such as operational schedule information for one or more radios located in an apparatus, or may pertain to foreign signals detected by apparatuses in the environment. For example, networked apparatuses may be able to detect signals in the environment that were emitted by non-networked signal sources. This signal information may be evaluated in order to predict overall signal activity in the environment over a period of time. Various embodiments of the present invention may use the predicted signal activity to determine if schedule scans may potentially encounter interference.

Communication management in view of signal-activity present in the operational environment may help to reduce interference (e.g., reduction in bit-errors), which may result in improved radio resource usage, spectrum efficiency and enhanced overall QoS. Such operation may also be part of a communication management strategy to fulfill requirements for partially restricted unlicensed operation, such as the −114 dBm sensing criteria required by the FCC in TVWS networking. In particular, the FCC requires that all TVWS apparatuses shall perform scanning for incumbent (e.g., legacy) apparatuses. At least one challenge presented by this requirement is that the scanning should be performed simultaneously by all apparatuses in a certain geo-location (area) so that there is no TVWS transmission by any TVWS apparatuses in order to avoid interference with the scan. Therefore, the scan timing (e.g., instances where scanning is planned to occur) should be known to all TVWS apparatuses beforehand. Mobile devices may spend large portion of their time in a sleep mode as a power saving measure, and thus, signaling a scan instance just before a sleeping window does not present a feasible solution. As a result, scan intervals typically fall on a predetermined interval negotiated between TVWS apparatuses. Using a fixed interval may be the simplest configuration, however, such a solution does not account for instances when the interval may fall closely in time with legacy apparatus transmission (e.g., possibly masking the ability to sense incumbent apparatuses). Thus, the actual interval may have some variation but will always be negotiated between apparatuses beforehand.

Accounting for co-located radio coexistence makes scanning even more difficult. Co-located coexistence can be problematic in that the other co-located non-cognitive radios may not support such scanning periodicity. Co-located radio transmission/reception patterns depend on technology. For example, the Global System for Mobile Communications (GSM) is based on time-division multiplexing (TDM), while the Universal Mobile Telecommunication System (UMTS) is more continuous Wideband Code Division Multiple Access (WCDMA) transmission.

In accordance with at least one embodiment of the present invention, a solution to these challenges may involve a frequency-based optimization strategy. This solution, along with the time-based optimization strategy, will be described with respect to the example disclosed in FIG. 4. In general, apparatuses 334 and 336 may provide apparatus-related information and sensed environmental information to apparatus 332. Apparatus 332 may further receive network-related information (e.g., if the apparatus contains resource management functionality for maintaining the network) and may also sense environmental information itself. Apparatus 332 may then provide control information back to apparatuses 334 and 336.

In embodiments relating to frequency-based optimization, TVWS apparatuses including co-located radios (e.g., TVWS PP mode 1 apparatus 334) may inform (e.g., send reporting messages) comprising preferred channel or frequency information to a TVWS Master apparatus (e.g., fixed apparatus 332), which may consider this information when making channel selection decisions. In view of this information, the TVWS master device may allocate channels which it predicts will result in the least amount interference between TVWS technology and co-located radios, sensed signals in the environment, etc. TVWS apparatuses may also employ a special sensing-only mode in order to determine channel availability. In this mode, devices could form ad hoc networks without TVWS database access or any centralized control. Apparatuses in this special mode could scan all (or at least a subset of all) of the channels, and report to each other which channels are sensed as free. This information may be used to create a list of available channels based on sensing results only. This information may be used with the previously described co-located radio information to decide the channels in which the ad hoc network should operate to minimize interference.

The co-located radio and available channel information may be reported in an abstract manner. For example, the information may simply reference a high/low TV channel (or frequency) as available depending on the frequency of the other radio which may potentially cause interference. In theory, there may also be multiple active radios both above and below TVWS channels. In such cases middle channels may be deemed optimal. Alternatively, the information may be more accurate, like indications to use certain channel number(s), certain frequencies or to operate above/below certain channel numbers. Moreover, in situations where TVWS apparatuses can control channel selection themselves (e.g., PP Mode II devices), these apparatuses may just select the most suitable channel in view of its own internal selection logic.

In example implementations a TVWS_colocated_channel_req message may be sent to other TVWS apparatuses in the operational environment. This message may comprise fields such as “State” which may indicate activated or deactivated with respect to co-located radios (e.g., this parameter may indicate the start and the stop of co-located radio operation), “Channel Number” X, where X=20-51 may indicate a requested channel which is the highest or lowest allowed for TVWS operation, and “Direction” which may indicate High or Low (e.g., the channels should be avoided). This message may be sent when TVWS apparatuses have two concurrently active radios (e.g., a TVWS radio and another co-located radio) that may potentially interfere with each other or when such concurrent radio operation is stopped. Requested channel info may be taken account when there are available channels for fulfilling a request (or multiple requests from different TVWS apparatuses).

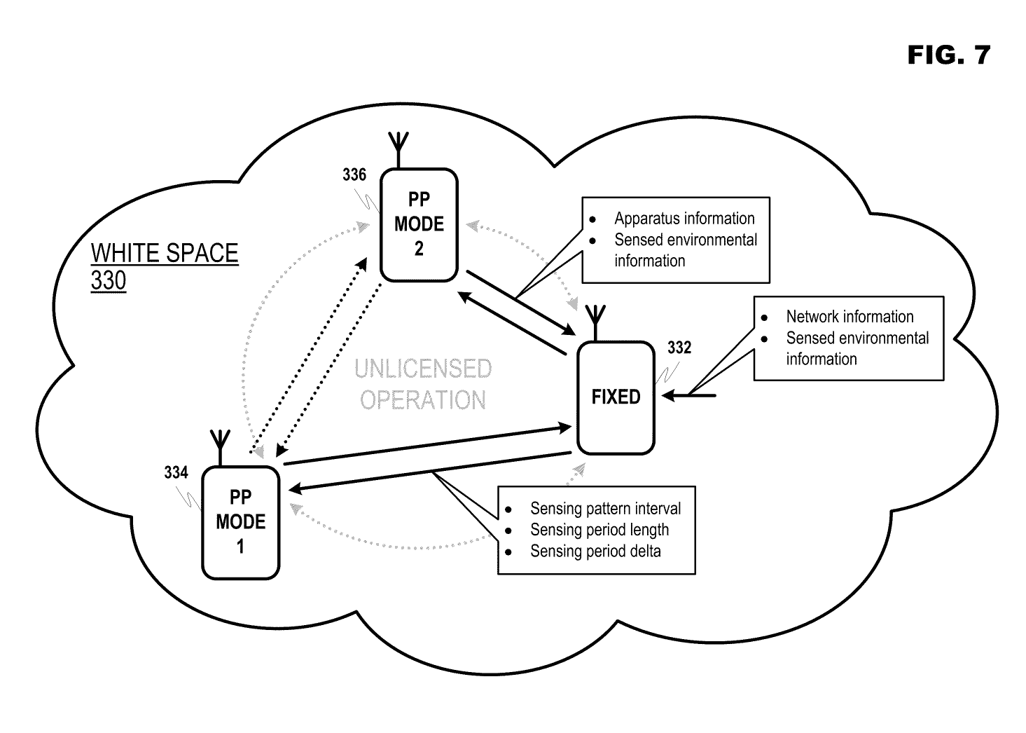

In accordance with at least one embodiment of the present invention, time-based optimization is also a control strategy that may be employed in view of the general control example disclosed in FIG. 7. Most radio technologies operate in a manner where breaks occasionally occur in communication activities. Breaks may occur simply due to a lack of transmission (either uplink or downlink) for an apparatus, power saving mechanisms that place apparatuses in sleep/idle modes, etc. In accordance with at least one embodiment of the present invention, these breaks may be used for scanning in TVWS systems (e.g., if the breaks for all apparatuses are aligned). However, the timing of these breaks may not necessarily line up with the previously established (e.g., periodic) scanning instances known in the TVWS network. Using a time based solution, TVWS devices may determine available timing intervals for scanning based on information communicated between the TVWS apparatuses. For example, co-located radio transmission schedules or power saving patterns of apparatuses may be compared to the TVWS scanning schedule (e.g., scanning instances, pre-established scanning interval, etc.). If, for example, the operation of co-located radios may overlap with the sensing period, and such an occurrence may cause the criteria established by the FCC to be violated, then TVWS apparatuses may perform corrective action. For example, if an apparatus cannot control scan interval itself (e.g., operating in a slave role) it may send some or all of the signal and scan schedule information to another TVWS apparatus which may decide how to alter the timing of scan schedule. On the other hand, an apparatus operating in a master role may adjust sensing period and/or instance by itself, which would be especially useful if cooperative control between different TVWS apparatuses is possible.

V. Implementation Example for Networks that do not Support Collaborative Coexistence

FIG. 7 discloses an example of how sensing patterns may be established through the use of cognitive radio (CR) functionality. In particular, information may be transmitted from apparatuses that are operating in a particular environment (e.g., TVWS) to a CR system that uses the received information for formulating sensing pattern interval and duration information. The sensing pattern interval and duration information may be then distributed to the apparatuses for synchronizing sensing operations in the particular environment. Thus, collaborative coexistence may be established to provide awareness of apparatuses operating in the particular environment, and especially of legacy equipment activities, in order to reduce the potential for interferences.

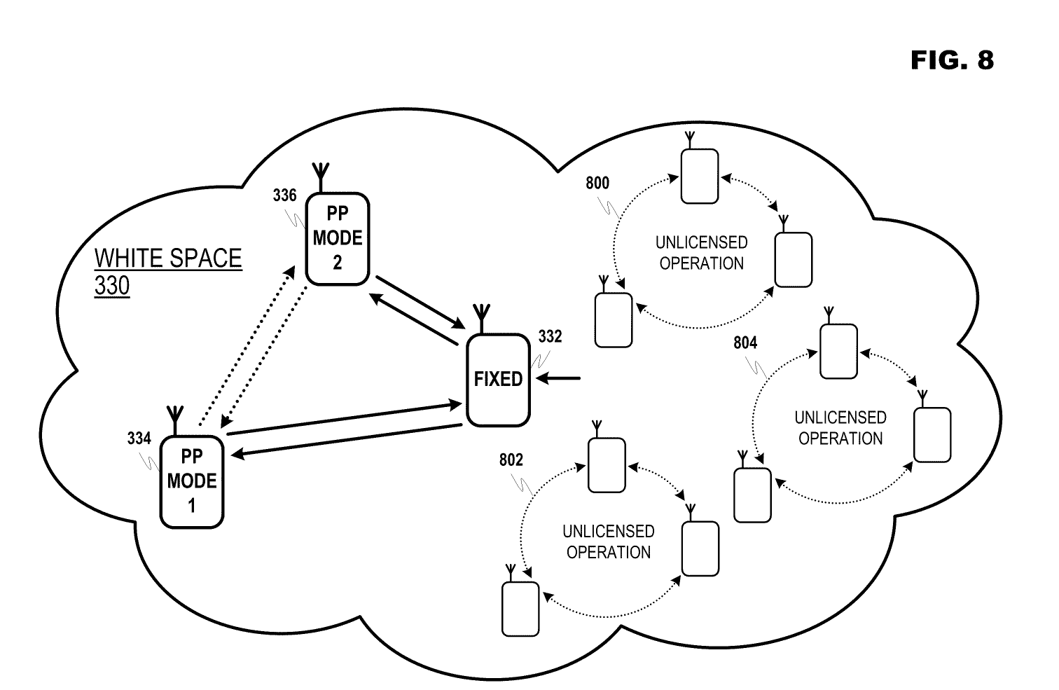

However, it is also possible that some apparatuses operating in this bandwidth do not support collaborative coexistence. That is, some wireless-enabled apparatuses may have the capability of operating in a network, or even to act as a master apparatus for forming and/or maintaining a wireless network, but do not have the ability to exchange information that would be usable for establishing sensing periods that are synchronized with other apparatuses sharing TVWS 330. An example scenario is disclosed with respect to FIG. 8. In addition to apparatuses 332-336 that, per FIG. 7, may coexist via collaborative operations, networks 800, 802 and 804 may also operate in TVWS 330. The networks may be established and/or maintained by master apparatuses that may set general operational parameters within each network. However, these master apparatuses may lack the functionality required to support collaborative coexistence (e.g., no CR system 500 resources), and thus, networks 800, 802 and 804 may not be able to establish sensing parameters based on the operation of other apparatuses that are also sharing TVWS 330.

In accordance with at least one embodiment of the present invention, apparatuses that do no possess the ability to coexist collaboratively with other apparatuses may still operate in environments having sensing requirements, and in the course of this operation may still make an effort to customize operation in accordance with the operation of other apparatuses in the operational environment. In at least one example implementation, apparatuses that lack true cognitive radio capabilities may still listen for quiet periods that have already been established by other apparatuses in an environment, and in view of one or more rules and/or conditions, may attempt to conform apparatus and/or network operations (e.g., in the case of network master apparatuses) to the detected quiet period timing and duration. These rules and/or conditions may also include provisions for situations when no quiet periods are sensed.

More specifically, the rules and/or conditions may provide for the establishment of quiet period timing and duration and silent period timing and duration in apparatuses/networks that do not participate in collaborative coexistence. Quiet periods may be abstract or figurative periods of time during which apparatuses may operate with the understanding that no wireless communications should be allowed to take place. For example, apparatuses may listen for periods of time that contain no signal activity, or signal activity below a threshold level, and may determine based on the lack of substantial signal activity that a quiet period occurred during the period of time. In accordance with at least one embodiment of the present invention, master apparatuses may then schedule silent periods, in individual apparatuses or network-wide, wherein communication is prohibited in order to respect these quiet periods. In this manner, apparatuses/networks that do not support collaborative coexistence may still act in a manner that attempts to support legacy equipment sensing requirements in the environment.

Apparatuses/networks that are able to adopt quiet period timing and/or duration based on existing operations within an environment may be beneficial in that already established sensing periods may be respected, and thus, the ability to sense legacy equipment also operating in the environment may be enhanced. However, in some instances it may not be possible for non-collaborative apparatuses/networks to accurately detect already existing quiet periods. For example, if no wireless networks are in operation there would be no quiet periods to detect. In such instances, the aforementioned rules and/or conditions may also set forth provisions that allow apparatuses to establish new quiet period timing and duration (e.g., local to their network). Apparatuses may then create silent periods for their respective networks in order to enforce these quiet periods. Secondary non-collaborative networks that subsequently form in the environment may detect these silent periods, and adopt the previously established quiet period timing and duration based on the rules and/or conditions that were set forth above.

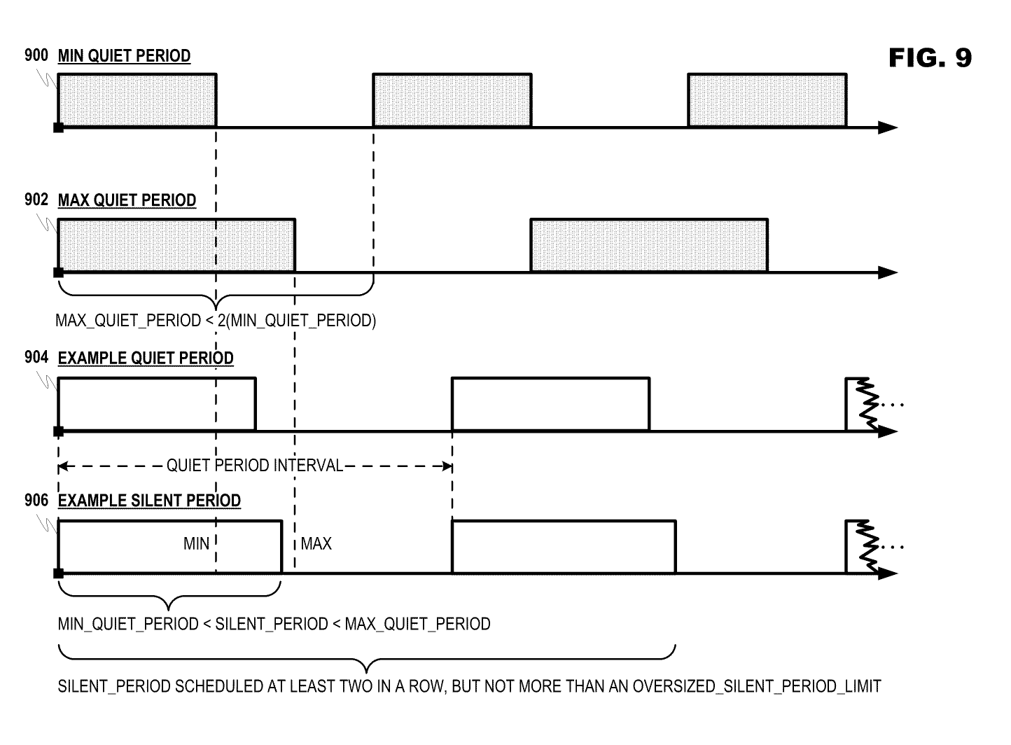

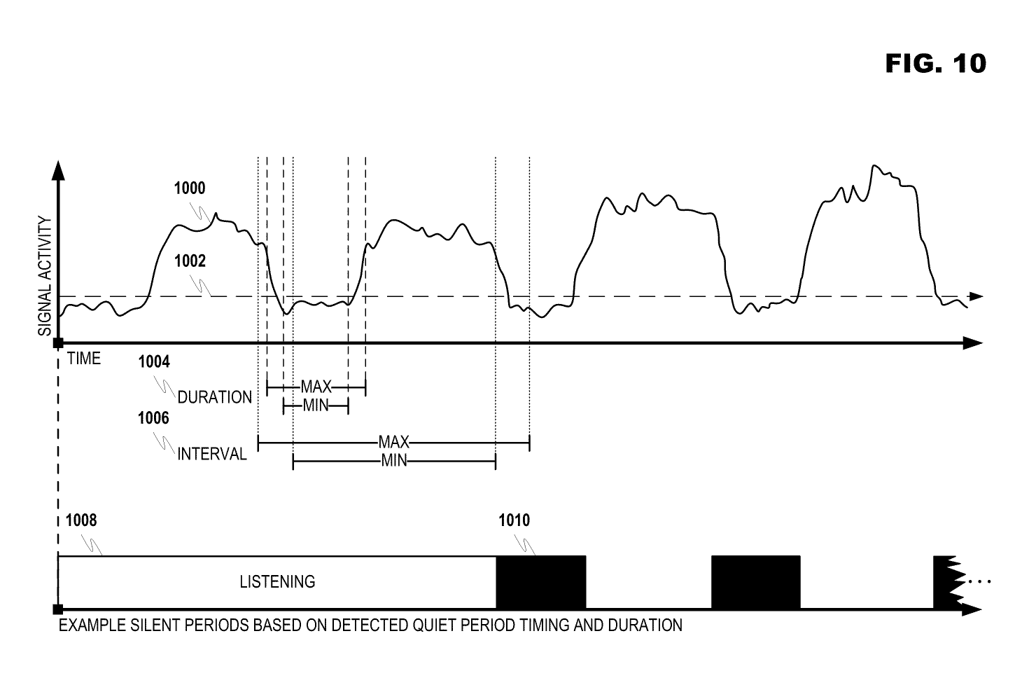

FIG. 9 defines some example parameters that will be used in describing example quiet period listening and/or silent period formation in FIG. 10. In accordance with at least one embodiment of the present invention, minimum quiet period duration (MIN_QUIET_PERIOD) and maximum quiet period duration (MAX_QUIET_PERIOD) may be defined as set forth at 900 and 902 in FIG. 9. These parameters may be interrelated, such as in the example of FIG. 9 where the duration of maximum quiet period 902 is less than the total duration of two minimum quiet periods 900. While such a relationship governs the example parameters of FIG. 9, the embodiments of the present invention are not limited by this relationship, as other relationships may exist based on factors such as environment, communication transports, apparatuses, etc.

The durations of minimum quiet period 900 and maximum quiet period 902 may be predetermined in accordance with environment (e.g., TVWS 330), communication transports, apparatuses, etc., or may be determined empirically through listening operations. In an example of empirical establishment, apparatuses, such as master apparatuses of the network, may adopt quiet period timing and duration based on listening results, and the listening results may be utilized for establishing minimum quiet period duration 900 and maximum quiet period duration 902 based on the shortest/longest quiet periods that were detected. In an alternative example implementation, the master apparatus may subtract and add some time (e.g., a percentage or a fixed time period) to an average detected quiet period duration in order to compute minimum and maximum quiet period durations, respectively.

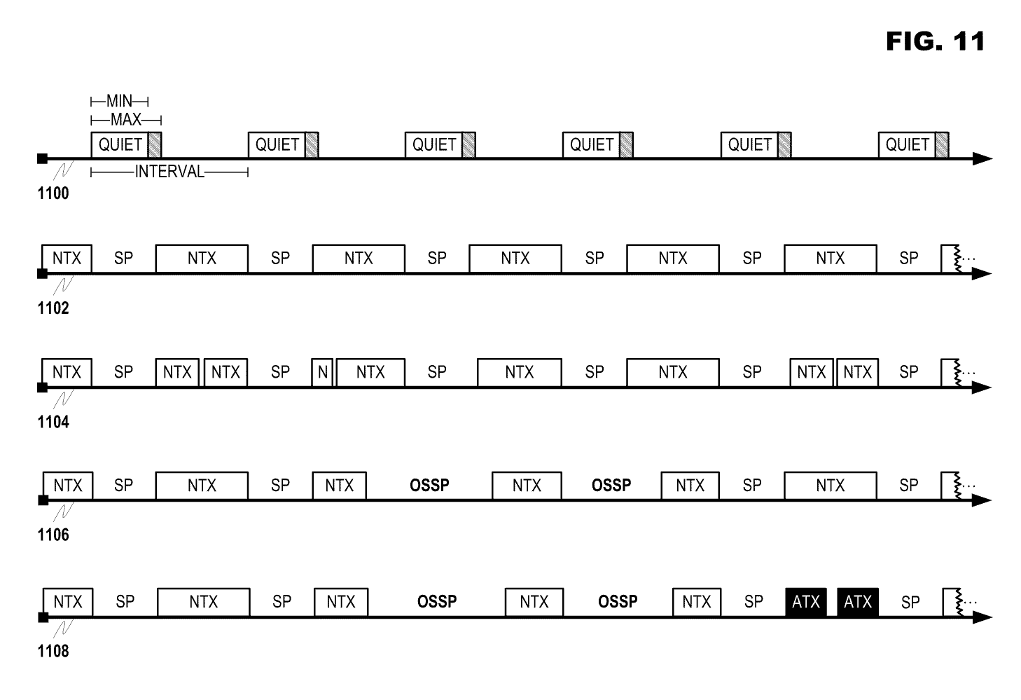

Adopting quiet period timing and duration based on listening quiet periods, or alternatively, establishing new quiet period timing and duration within a network, may result in example quiet periods such as disclosed at 904. Regardless of how the quiet period timing and duration is established, master apparatuses will eventually establish silent periods in the networks they manage to enforce quiet periods. Example silent periods are disclosed at 906 in FIG. 9. As disclosed above, various rules and/or conditions may control silent period formation. For example, a basic relationship may exist wherein the established duration of a silent period is defined by MIN_QUIET_PERIOD<SILENT_PERIOD<MAX_QUIET_PERIOD. However, as will be seen with respect to FIG. 11, there may be instances where communication conditions existing within networks may result in additional periods of time without communication that cause the actual duration of one or more silent periods to exceed the established duration, and as a result, “oversized” silent periods may exist. Other relationships may control silent period timing. As shown in FIG. 9, silent periods may be scheduled so that their start times coincide with the interval (e.g., the start times) of the adopted or newly established quiet period timing. Further, the number of oversized silent periods that can be scheduled together may not exceed the number of silent periods set forth in an OVERSIZED_SILENT_PERIOD_LIMIT parameter. This limitation may affect network operation, and will be discussed further in regard to FIG. 11.

In accordance with at least one embodiment of the present invention, an example of quiet period detection and silent period establishment is disclosed in FIG. 10. Signal activity in the environment that apparatuses may detect is disclosed at 1000 in FIG. 10. Apparatuses may have some parameters to which they may compare the detected signal activity when attempting to determine quiet period timing and duration. For example, a threshold level 1002 may define a level of signal activity under which sensed signal activity may be considered “quiet.” Therefore, when the signal activity being sensed drops below the threshold level, apparatuses may consider that they detected an existing silent period in the environment. In FIG. 10, detected signal activity 1000 begins below threshold 1002 and then rises above this threshold. The listening apparatus (e.g., a master apparatus) may consider the first period of time where detected signal activity 1000 stays below threshold 1002 to be a first silent period. Detected signal activity 1000 then maintains a level above threshold 1002 for some time before again dropping below threshold level 1002. Each time signal activity 1000 drops below threshold 1002 may be considered a potential silent period, which may result in many potential silent periods of various durations. In accordance with at least one embodiment of the present invention, if minimum quiet period duration 900 and maximum quiet period duration 902 are known beforehand (e.g., predetermined), such as disclosed at 1004 in FIG. 10, then the potential silent periods may be evaluated in view of these parameters to determine whether they fall within these bounds, and are thus actual quiet periods.

In addition, listening apparatuses may be aware of minimum and maximum quiet period intervals, which is set forth in FIG. 10 at 1006. The minimum and maximum quiet period intervals may be predetermined, for example, based on the particular operational environment, the wireless transports being utilized, etc. The duration of time that occurs between two silent periods detected in a manner such as set forth above, may define a silent period interval, and the silent period interval may be compared to the minimum and maximum quiet period intervals to confirm that the detected silent period interval falls within these bounds. It therefore becomes evident in FIG. 10 that apparatuses must sense at least two silent periods in order to adopt a quiet period timing and duration based on the detected silent period timing and duration. After listening 1008 concludes in FIG. 10, a listening apparatus (e.g., a master apparatus) may have established both quiet period timing and duration. The listening apparatus may then establish silent periods 1010 based on the quiet period timing and duration. Each silent period is initiated at an interval based on the quiet period timing. Moreover, a rule and/or condition may dictate that all silent periods be scheduled in pairs. Scheduling at least two silent periods at a time may allow secondary networks that established in the environment at a later time to detect both silent period duration and timing, and in a similar manner they may adopt the same quiet period timing. In other words, the silent period timing and duration of existing networks is the quiet period timing and duration detected by later-formed networks, and thus, at least two silent periods must be sensed by the later-formed network in order to adopt both quiet period timing and duration.

FIG. 11 discloses various examples of silent period timing and duration that may result from adopted or newly established quiet period timing and duration. Example quiet period timing and duration is disclosed at 1100. The example activity flow disclosed at 1102 may pertain to a very active network. The silent periods are scheduled to start in accordance with the quiet period interval, and these periods have a duration substantially the same length as the quiet period. The other time in the activity flow is filled with network communication (NTX). Example activity flow 1102 may be considered “normal” in that the silent periods are uniform and match the timing and duration of the quiet periods set forth in example activity flow 1100.

The example activity flow disclosed at 1104 may describe a network experiencing less activity than in the example activity flow disclosed at 1102. Additional periods of unused network time are now apparent, but the unused network time has not affected the integrity of the silent periods, which are still somewhat uniform and conform to the rules and/or conditions that govern silent period timing and duration. However, the integrity of the silent periods is starting to be influenced in the example activity flow disclosed at 1106. Initially, at least two “standard” silent periods may be scheduled within the network, but a lack of network activity may result in additional time periods that extend the duration of silent periods, resulting in oversized silent periods (OSSP). In particular, silent periods are still being respected within the network in that periods of time where signaling is prohibited within the network are still being initiated at the quiet period interval. However, as periods of network inactivity expand the duration of time without interaction between network members increases, which may affect network integrity.

The occurrence of multiple oversized time periods may affect network integrity in that timing, such as quiet period timing and duration, may not be set by the master apparatus. In order to avoid this situation, the number of multiple oversized time periods may be governed by the OVERSIZED_SILENT_PERIOD_LIMIT parameter. This rule may limit the total number of oversized silent periods that may occur in a row. In the example activity flow set forth at 1106, the OVERSIZED_SILENT_PERIOD_LIMIT may be two, and thus, the network may be forced to again schedule a normal sized silent period after the occurrence of the second oversized silent period. In accordance with at least one embodiment of the present invention, it may be necessary for the master apparatuses that manage networks 800-804 to execute special signaling in order to keep the apparatuses in the network synchronized. For example, these master apparatuses may need to generate some sort of artificial transmissions just before or just after an oversized silent period in order to keep the networked apparatuses in time with the network and up to date regarding quiet and/or silent period timing and duration. An example of such signaling is shown in the example activity flow disclosed at 1108. The lack of normal network activity (NTX) scheduled after the second OSSP may necessitate one or more artificial transmissions (ATX).

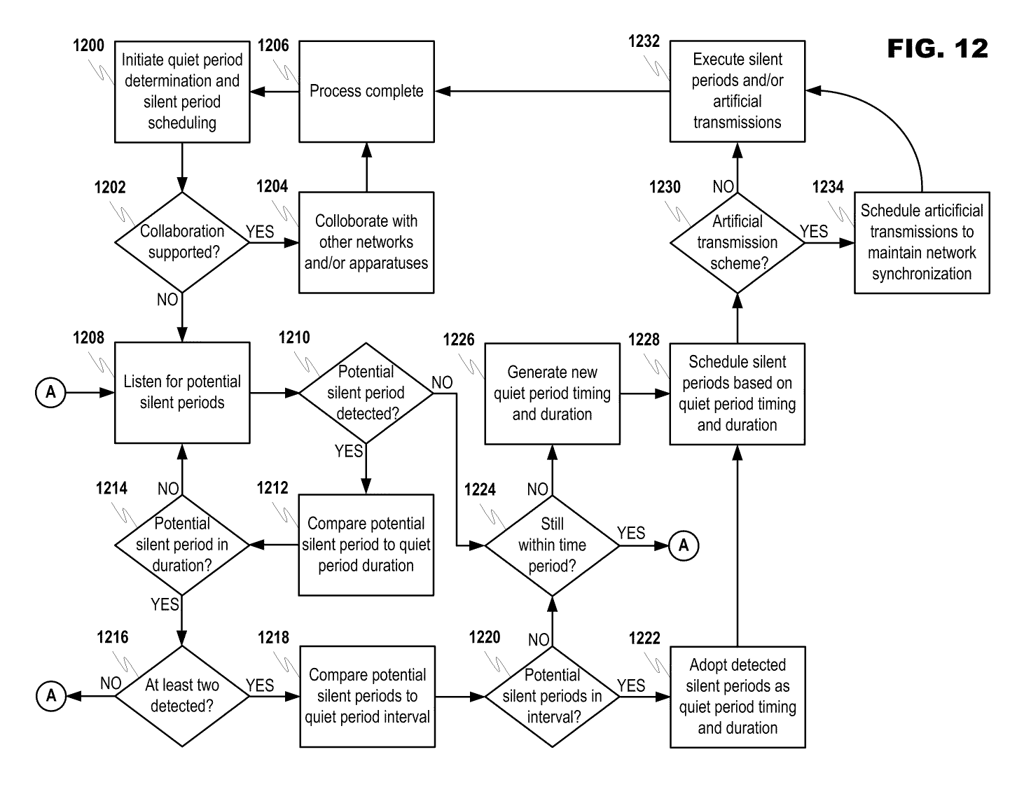

A flowchart of an example process in accordance with at least one embodiment of the present invention is now disclosed with respect to FIG. 12. A quiet period determination and silent period scheduling process may initiate in step 1200. In step 1202 a determination may be made as to whether the apparatus performing the process disclosed in FIG. 12 (e.g., a master apparatus of a wireless network) supports collaborative coexistence. For example, the apparatus may be capable of collaborative coexistence if it supports Cognitive Radio (CR) functionality. If collaborative coexistence is supported, then in step 1204 at least the apparatus may collaborate with other apparatuses and/or networks that are operating in the environment by exchanging information such as quiet period timing and duration. The process may then terminate in step 1206 and may return to step 1200 in preparation for subsequent quiet period determination and silent period scheduling process initiation.

If in step 1202 collaborative coexistence is determined not to be supported, then in step 1208 at least the apparatus may began to listen for silent periods in the environment. It is again important to understand that quiet periods exist only within apparatuses and represent time periods during which an apparatus believes that no communication should take place, and that silent periods are the physical manifestation of already established quiet periods being enforced by apparatuses/networks in the environment. Thus, when apparatuses are determining whether quiet period timing and duration has already been established in an environment, they are really listening for silent periods that are occurring in the environment. If potential silent periods are detected in step 1210, then the potential silent period may be compared to predetermined quiet period criteria. For example, if the duration of the potential silent period is between the minimum and maximum quiet period duration in steps 1212 and 1214, and at least two silent periods have been detected in step 1216 so that the timing of the silent periods is between the minimum and maximum quiet period interval in steps 1218 and 1220, then the potential silent periods may be deemed actual silent periods and in step 1222 the actual silent period timing and duration may be adopted as quiet period timing and duration in the apparatus. Otherwise, the process may return to step 1208, either from decision step 1214 or from decision step 1216 as indicated by referral reference “A”, in order to listen for additional potential silent periods.

It is also important to note that there may be instances where no silent periods are detected, potential or otherwise, within a predetermined time period as determined in step 1224. In such instances the apparatus may generate new quiet period timing and duration in step 1226. This may occur, for example, when no apparatuses are operating within the environment (the apparatus is the first apparatus), or in instances where silent periods that fall within the quiet period criteria cannot be detected (e.g., when in step 1220 the timing of the potential silent periods is outside of the minimum and maximum quiet period interval) with the predetermined time period. Regardless of whether the quiet period timing was adopted in step 1222 or newly created in step 1226, the quiet period timing and duration may then be utilized by the apparatus in step 1228 to schedule silent periods for respecting the quiet periods (e.g., within the network). A determination may then be made in step 1230 as to whether an artificial transmission scheme will be necessary, for example, in order to maintain network timing. An artificial transmission scheme may be deemed necessary if, for example, long periods of time are created by the silent periods where network interaction will be prohibited. If no artificial transmission scheme is necessary, then the silent periods may be executed as scheduled in step 1232 and then process may terminate in step 1206. However, if an artificial transmission scheme is deemed necessary in step 1230 then the process may proceed to step 1234 where artificial transmissions may be scheduled in order to maintain network timing. The process may then return to step 1232 where both the scheduled silent periods and the one or more scheduled artificial transmissions may be executed. The process may then terminate in step 1206 and return to step 1200 in preparation for quiet period determination and silent period scheduling processes to be initiated.

While various exemplary configurations of the present invention have been disclosed above, the present invention is not strictly limited to the previous embodiments.

For example, the present invention may include, in accordance with at least one example embodiment, an apparatus comprising means for listening for potential silent periods to occur in an environment, the listening being performed for a predetermined time period by an apparatus in a wireless network operating in the environment, means for, upon detecting potential silent periods, determining if the potential silent periods are actual silent periods by comparing the potential silent periods to quiet period criteria, means for, if at least two subsequent actual silent periods are determined, adopting quiet period timing and duration in the apparatus based on the at least two detected actual silent periods, and means for, if at least two actual silent periods are not sensed, establishing new quiet period timing and duration in the apparatus based on the quiet period criteria.

At least one other example embodiment of the present invention may include electronic signals that cause apparatuses to listen for potential silent periods to occur in an environment, the listening being performed for a predetermined period of time by an apparatus in a wireless network operating in the environment, upon detecting potential silent periods, determining if the potential silent periods are actual silent periods by comparing the potential silent periods to quiet period criteria, if at least two subsequent actual silent periods are determined, adopting quiet period timing and duration in the apparatus based on the at least two detected actual silent periods, and if at least two actual silent periods are not sensed, establishing new quiet period timing and duration in the apparatus based on the quiet period criteria.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
listening for potential silent periods to occur in an environment, the listening being performed for a predetermined time period by an apparatus in a wireless network operating in the environment;
upon detecting potential silent periods, determining if the potential silent periods are actual silent periods by comparing the potential silent periods to quiet period criteria;
if at least two subsequent actual silent periods are determined, adopting quiet period timing and duration in the apparatus based on the at least two detected actual silent periods; and
if at least two actual silent periods are not detected, establishing new quiet period timing and duration in the apparatus based on the quiet period criteria.

2. The method of claim 1, wherein the apparatus is a master apparatus configured to maintain the wireless network.

3. The method of claim 1, wherein listening for silent periods is not performed by the apparatus if collaborative coexistence functionality is supported in the apparatus; and
further wherein the quiet period timing and duration is established based on information exchanged by the apparatus via the collaborative coexistence functionality.

4. The method of claim 1, wherein listening for potential silent periods comprises listening for signal activity in the environment to fall below a predetermined threshold level.

5. The method of claim 1, wherein the quiet period criteria comprises a maximum and minimum quiet period duration and a maximum and minimum quiet period interval.

6. The method of claim 1, further comprising establishing silent periods in the wireless network during which communication is prohibited, the silent periods being established by the apparatus in at least pairs that are based on the quiet period timing and duration.

7. The method of claim 6, wherein oversized quiet periods occur when unused time in the network causes established silent period duration to be longer than a maximum quiet period duration, and the number of successive oversized quiet periods is limited by an oversized silent period limit.

8. The method of claim 7, wherein the occurrence of successive oversized quiet periods causes the apparatus to maintain timing in the wireless network by establishing artificial signaling.

9. A computer program product comprising computer executable program code recorded on a computer readable storage medium, the computer executable program code comprising:
code configured to cause an apparatus in a wireless network to listen for potential silent periods to occur in an environment, the listening being performed for a predetermined time period;
code configured to cause an apparatus to, upon detecting potential silent periods, determine if the potential silent periods are actual silent periods by comparing the potential silent periods to quiet period criteria;
code configured to cause an apparatus to, if at least two subsequent actual silent periods are determined, adopt quiet period timing and duration in the apparatus based on the at least two detected actual silent periods; and
code configured to cause an apparatus to, if at least two actual silent periods are not detected, establish new quiet period timing and duration in the apparatus based on the quiet period criteria.

10. The computer program product of claim 9, wherein the code configured to cause the apparatus to listen for potential silent periods is not executed if collaborative coexistence functionality is supported in the apparatus, the code being further configured to cause the apparatus to establish the quiet period timing and duration based on information exchanged by the apparatus via the collaborative coexistence functionality.

11. The computer program product of claim 9, wherein the code configured to cause the apparatus to listen for potential silent periods further comprises code configured to cause the apparatus to listen for signal activity in the environment to fall below a predetermined threshold level.

12. The computer program product of claim 9, wherein the quiet period criteria comprises a maximum and minimum quiet period duration and a maximum and minimum quiet period interval.

13. The computer program product of claim 9, further comprising code configured to cause the apparatus to establish silent periods in the wireless network during which communication is prohibited, the silent periods being established by the apparatus in at least pairs that are based on the quiet period timing and duration.

14. The computer program product of claim 13, wherein oversized quiet periods occur when unused time in the network causes established silent period duration to be longer than a maximum quiet period duration, and the number of successive oversized quiet periods is limited by an oversized silent period limit.

15. The computer program product of claim 14, further comprising code configured to cause the apparatus to maintain timing in the wireless network by establishing artificial signaling when the occurrence of successive oversized quiet periods reach the oversized silent period limit.

16. An apparatus, comprising:
at least one processor; and
at least one memory including executable instructions, the at least one memory and the executable instructions being configured to, in cooperation with the at least one processor, cause the apparatus to perform at least the following:
listen for potential silent periods to occur in an environment in which a network including the apparatus is operating, the listening being performed for a predetermined time period;
upon detecting potential silent periods, determine if the potential silent periods are actual silent periods by comparing the potential silent periods to quiet period criteria;
if at least two subsequent actual silent periods are determined, adopt quiet period timing and duration in the apparatus based on the at least two detected actual silent periods; and
if at least two actual silent periods are not detected, establish new quiet period timing and duration in the apparatus based on the quiet period criteria.

17. The apparatus of claim 17, wherein the apparatus is a master apparatus configured to maintain the wireless network.

18. The apparatus of claim 17, wherein the at least one memory and the executable instructions are further configured to, in cooperation with the at least one processor, cause the apparatus to not listen for silent periods if collaborative coexistence functionality is supported in the apparatus, and are further configured to cause the apparatus to establish the quiet period timing and duration based on information exchanged by the apparatus via the collaborative coexistence functionality.

19. The apparatus of claim 17, wherein the at least one memory and the executable instructions being configured to, in cooperation with the at least one processor, cause the apparatus to listen for potential silent periods further comprises the at least one memory and the executable instructions being configured to, in cooperation with the at least one processor, cause the apparatus to listen for signal activity in the environment to fall below a predetermined threshold level.

20. The apparatus of claim 17, wherein the quiet period criteria comprises a maximum and minimum quiet period duration and a maximum and minimum quiet period interval.

21. The apparatus of claim 17, wherein the at least one memory and the executable instructions are further configured to, in cooperation with the at least one processor, cause the apparatus to establish silent periods in the wireless network during which communication is prohibited, the silent periods being established by the apparatus in at least pairs that are based on the quiet period timing and duration.

22. The apparatus of claim 21, wherein oversized quiet periods occur when unused time in the network causes established silent period duration to be longer than a maximum quiet period duration, and the number of successive oversized quiet periods is limited by an oversized silent period limit.

23. The method of claim 22, wherein the at least one memory and the executable instructions are configured to, in cooperation with the at least one processor, cause the apparatus to maintain timing in the wireless network by establishing artificial signaling when the occurrence of successive oversized quiet periods reach the oversized silent period limit.
